(19) United States
(12) Patent Application Publication
(10) Pub. No.: US 2026/0200196 A1
(43) Pub. Date: Jul. 16, 2026

(54) PRECISIPON PRESS APPARATUS

(71) Applicant: VD Corp., Yongin-si (KR)

(72) Inventor: JAEHYEOCK CHANG, SEOUL (KR)

(21) Appl. No.: 19/448,095

(22) Filed: Jan. 13, 2026

(30) Foreign Application Priority Data
Jan. 14, 2025 (KR) 10-2025-005244

(51) Int. Cl. B30B 15/14; B30B 15/00; B30B 15/04

(52) U.S. Cl. CPC B30B 15/148; B30B 15/0064; B30B 15/041

(57) ABSTRACT

Provided is a precision press apparatus. A Z-axis driving mechanism may include a Z-axis moving stage connected to a main load cell mounted on a pressing head. A Y-axis driving mechanism may include a Y-axis moving stage fixed to a Z-axis base of the Z-axis driving mechanism, a gantry configured to connect Y-axis fixed stages, a Y-axis auxiliary stage spaced from the Y-axis moving stage along the Z-axis, inner flexures connected between the Y-axis auxiliary stage and the Y-axis moving stage, outer flexures connected between the Y-axis auxiliary stage and the Y-axis fixed stages, and a Y-axis actuator configured to move the Y-axis moving stage. The load compensation mechanism may apply a force between the Z-axis base and the gantry, based on the pressing force measured by the main load cell, to cancel a vertical reaction force acting on the pressing head.

### TECHNICAL FIELD

The present invention relates to a precision press apparatus, such as a semiconductor chip thermocompression bonder, that picks up a semiconductor chip with a pressing head and bonds the semiconductor chip to a substrate.

### BACKGROUND ART

A semiconductor chip thermocompression bonder is a type of precision press apparatus that picks up a semiconductor chip with a pressing head and bonds the semiconductor chip to a substrate. In the case of a semiconductor chip having bumps formed on a lower surface thereof, the semiconductor chip thermocompression bonder bonds the semiconductor chip by pressing the bumps against connection terminals of a substrate while the semiconductor chip is in a heated state.

The semiconductor chip thermocompression bonder may include a vertical driving mechanism that vertically lowers the pressing head along a vertical Z-axis, and a horizontal driving mechanism that horizontally moves the head along X- and Y-axes on a horizontal plane.

The vertical driving mechanism may be configured to vertically move a Z-axis moving stage, on which the pressing head is mounted, relative to a Z-axis base by a linear actuator. The horizontal driving mechanism may horizontally move the Z-axis base to horizontally move the pressing head.

The horizontal driving mechanism may include a flexure stage to transfer the pressing head by a fine displacement. The flexure stage controls precise movement by using elastic deformation of a flexure.

However, when a vertical reaction force corresponding to the pressing force is transmitted to the flexure stage via the vertical driving mechanism in a process of pressing the semiconductor chip with a pressing force of several hundred newtons (N), the flexure may be deformed into an undesired shape. As a result, horizontal positioning accuracy of the pressing head may be compromised, which may degrade the bonding quality of the semiconductor chip.

### DETAILED DESCRIPTION OF THE INVENTION

### Technical problem

An object of the present invention is to provide a precision press apparatus capable of ensuring horizontal positioning accuracy of a pressing head in a process of pressing an object with the pressing head.

### Technical Solution

To achieve the above object, a precision press apparatus according to the present invention includes a pressing head, a main load cell, a Z-axis driving mechanism, a Y-axis driving mechanism, and a load compensation mechanism. The main load cell may be mounted on an upper end of the pressing head to measure a pressing force applied to an object by the pressing head. The Z-axis driving mechanism may include a Z-axis moving stage connected to an upper end of the main load cell and configured to move along a vertical Z-axis, a Z-axis base configured to movably support the Z-axis moving stage along the Z-axis, and a Z-axis actuator configured to move the Z-axis moving stage along the Z-axis.

The Y-axis driving mechanism may include a Y-axis moving stage fixed to the Z-axis base and configured to move along a Y-axis on an XY horizontal plane, Y-axis fixed stages spaced outward from the Y-axis moving stage along the Y-axis, a gantry configured to connect the Y-axis fixed stages, a Y-axis auxiliary stage spaced upward from the Y-axis moving stage along the Z-axis, inner flexures connected between the Y-axis auxiliary stage and the Y-axis moving stage, outer flexures connected between the Y-axis auxiliary stage and the Y-axis fixed stages, and a Y-axis actuator configured to move the Y-axis moving stage along the Y-axis. The load compensation mechanism may apply a force between the Z-axis base and the gantry, based on the pressing force measured by the main load cell, to cancel a vertical reaction force acting on the pressing head.

Here, the gantry may be made of a magnetic material. The load compensation mechanism may include a load-compensation load cell and an electromagnet actuator for load compensation. The load-compensation load cell may be arranged on the same vertical axis as the main load cell and may be mounted to the Z-axis base. The electromagnet actuator for load compensation may be mounted on a lower end of the load-compensation load cell, apply a vertical attractive magnetic force to the gantry spaced downward therefrom, and generate the attractive magnetic force such that a force measured by the load-compensation load cell becomes equal to the pressing force measured by the main load cell.

### Advantageous Effects

According to the present invention, horizontal positioning accuracy of a pressing head can be secured in the process of pressing an object with the pressing head. In addition, according to the present invention, a dual flexure stage can be applied to a Y-axis driving mechanism even under operating conditions in which a pressing force of a substantial magnitude is applied to the object by the pressing head, thereby realizing the horizontal positioning accuracy of the pressing head.

### BRIEF DESCRIPTION OF DRAWINGS

FIG. 1 is a perspective view of a precision press apparatus according to an embodiment of the present invention.

FIG. 2 is a front view of FIG. 1.

FIG. 3 is a perspective view of a Y-axis driving mechanism extracted from FIG. 1.

FIG. 4 is a rear view of FIG. 3.

FIG. 5 is a view for describing an example operation of a load compensation mechanism in FIG. 1.

### DETAILED DESCRIPTION OF INVENTION

Hereinafter, the present invention will be described in detail with reference to the accompanying drawings. Here, like reference numerals denote like components, and repeated descriptions and detailed descriptions of well-known functions and configurations that may unnecessarily obscure the gist of the present invention will be omitted.

Embodiments of the present invention are provided to more completely explain the present invention to those of ordinary skill in the art. Accordingly, shapes and sizes of elements in the drawings may be exaggerated for clarity of description.

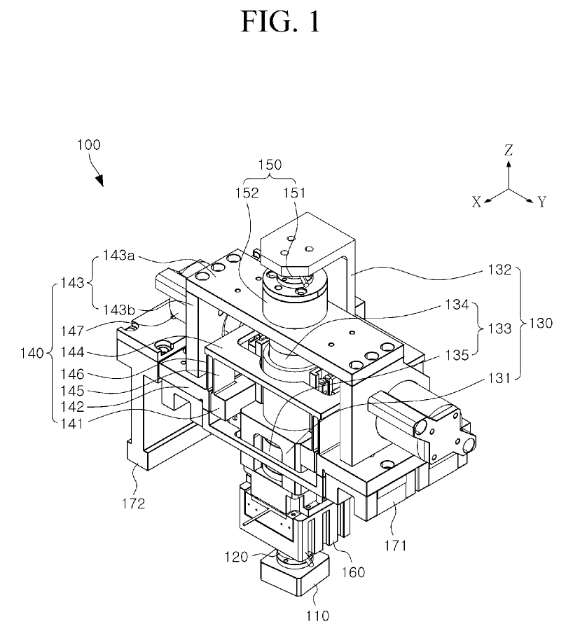

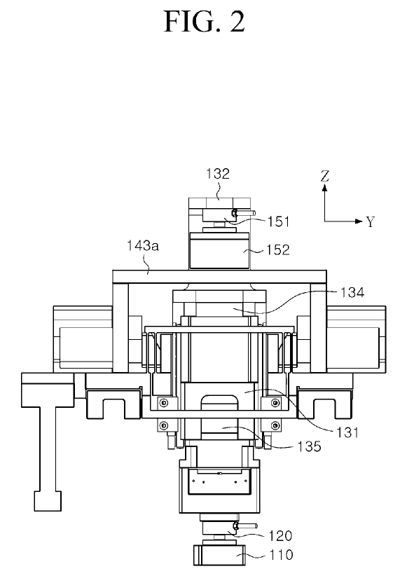

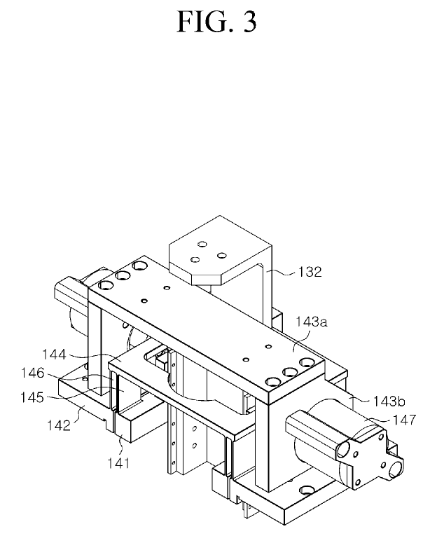

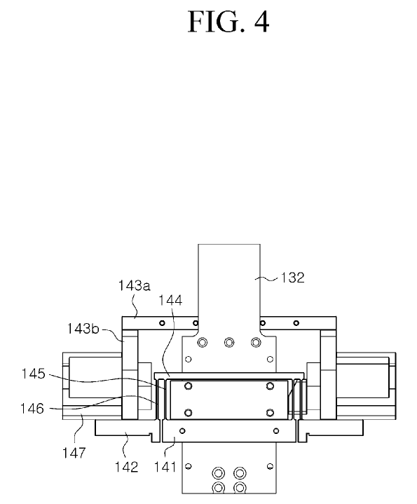

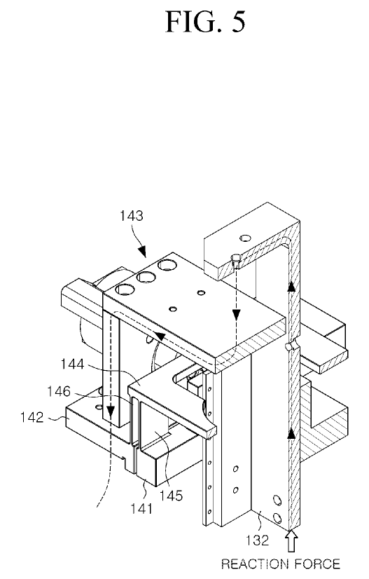

FIG. 1 is a perspective view of a precision press apparatus according to an embodiment of the present invention. FIG. 2 is a front view of FIG. 1. FIG. 3 is a perspective view of a Y-axis driving mechanism extracted from FIG. 1. FIG. 4 is a rear view of FIG. 3. FIG. 5 is a view for describing an example operation of a load compensation mechanism in FIG. 1.

Referring to FIGS. 1 to 5, a precision press apparatus 100 according to an embodiment of the present invention includes a pressing head 110, a main load cell 120, a Z-axis driving mechanism 130, a Y-axis driving mechanism 140, and a load compensation mechanism 150.

The pressing head 110 may be configured to adsorb an object, for example, a semiconductor chip, to a lower surface thereof using vacuum pressure or the like. The pressing head 110 may be lowered by the Z-axis driving mechanism 130 to press the adsorbed semiconductor chip against a substrate.

The main load cell 120 is mounted on an upper end of the pressing head 110 and measures a pressing force applied to the object by the pressing head 110. When the pressing head 110 applies the pressing force to the object, the main load cell 120 may measure the pressing force by measuring a vertical reaction force applied from the object to the pressing head 110. The pressing force measured by the main load cell 120 may be provided to an apparatus controller that overall controls the precision press apparatus 100. The main load cell 120 may have various known configurations.

The Z-axis driving mechanism 130 includes a Z-axis moving stage 131, a Z-axis base 132, and a Z-axis actuator 133. The Z-axis moving stage 131 is connected to an upper end of the main load cell 120 and moves along a vertical Z-axis. As the Z-axis moving stage 131 moves along the Z-axis, the Z-axis moving stage 131 may raise and lower the pressing head 110 connected to a lower end of the main load cell 120.

A rotation driving mechanism 160 may be mounted between the Z-axis moving stage 131 and the main load cell 120. The rotation driving mechanism 160 may adjust a rotational angle of the pressing head 110 by rotating the pressing head 110 about the Z-axis.

The rotation driving mechanism 160 may be configured to include various known rotation stages, such as a rotation stage using an ultrasonic motor. A fixed portion of the rotation stage may be fixed to the Z-axis moving stage 131, and a rotating portion of the rotation stage may be fixed to the main load cell 120. The rotation driving mechanism 160 may be controlled by the apparatus controller.

The Z-axis base 132 movably supports the Z-axis moving stage 131 along the Z-axis. Linear bearings may be mounted between the Z-axis base 132 and the Z-axis moving stage 131 to support movement of the Z-axis moving stage 131. The linear bearings may include linear cross-roller bearings.

The Z-axis actuator 133 moves the Z-axis moving stage 131 along the Z-axis. The Z-axis actuator 133 may be configured to include various known linear actuators. For example, the Z-axis actuator 133 may be configured in a tandem manner including a first actuator 134 on an upper side and a second actuator 135 on a lower side.

The first actuator 134 may primarily lower the Z-axis moving stage 131 by a large displacement to apply an initial pressure to the object through the pressing head 110. The second actuator 135 may secondarily lower the Z-axis moving stage 131 by a small displacement and apply a final pressure to the object through the pressing head 110 with a force greater than that of first actuator 134.

The first actuator 134 may be configured as an air-core coil actuator, for example, as a linear voice coil motor, and a stator thereof may be fixed to Z-axis base 132. A permanent magnet may be mounted on a mover of the linear voice coil motor, and a coil that linearly moves the mover by interacting with the permanent magnet according to application of current may be mounted on a stator of the linear voice coil motor.

The second actuator 135 may be configured as an iron-core coil actuator, for example, an electromagnet actuator, and may be fixed to the Z-axis base 132. The electromagnet actuator may be configured to generate a magnetic force by supplying current to a coil wound around an iron core. The first and second actuators 134 and 135 may be controlled by the apparatus controller.

The Z-axis moving stage 131 may be made of a non-magnetic material. An upper portion of the Z-axis moving stage 131 may be formed to partially surround the first actuator 134, and a mover of the first actuator 134 may be fixed on a lower side thereof. A middle portion of the Z-axis moving stage 131 may be formed to partially surround the second actuator 135, and may include, at an upper side thereof, an attraction plate made of a magnetic material that is attracted downward by an attractive magnetic force of the second actuator 135. A lower portion of the Z-axis moving stage 131 may be formed in a block shape, and may mount the rotation driving mechanism 160 on a lower end thereof.

The Y-axis driving mechanism 140 includes a Y-axis moving stage 141, Y-axis fixed stages 142, a gantry 143, a Y-axis auxiliary stage 144, inner flexures 145, outer flexures 146, and a Y-axis actuator 147.

The Y-axis moving stage 141 is fixed to the Z-axis base 132 and moves along a Y-axis on an XY horizontal plane. The Y-axis moving stage 141 may have a rectangular hollow portion penetrating vertically and may have a shape in which a front side is open. A rear portion of the Y-axis moving stage 141 may be fixed in a state of surrounding a rear surface of the Z-axis base 132. Left and right portions of the Y-axis moving stage 141 may be spaced outward from left and right surfaces of the Z-axis base 132.

The Y-axis fixed stages 142 are spaced outward from the Y-axis moving stage 141 along the Y-axis. A slider 171 movable in an X-axis direction may be mounted on a lower surface of each of the Y-axis fixed stages 142. The slider 171 may move while being guided by a rail extending along the X-axis.

An X-axis mover 172 of an X-axis driving mechanism may be fixed to any one of the Y-axis fixed stages 142. The X-axis mover 172 moves along the X-axis to move the Y-axis driving mechanism 140 and the Z-axis driving mechanism 130 along the X-axis, thereby moving the pressing head 110 along the X-axis.

The gantry 143 connects the Y-axis fixed stages 142. The gantry 143 may include a gantry horizontal plate 143a and gantry vertical plates 143b. The gantry horizontal plate 143a is disposed downward from an electromagnet actuator 152 for load compensation by a set gap. The gantry vertical plates 143b are connected between the gantry horizontal plate 143a and the Y-axis fixed stages 142. The gantry 143 may be made of a magnetic material so as to be pulled by an attractive magnetic force of the electromagnet actuator 152 for load compensation.

The Y-axis auxiliary stage 144 is spaced upward from the Y-axis moving stage 141 along the Z-axis. The Y-axis auxiliary stage 144 may have a rectangular hollow portion penetrating vertically to allow the Z-axis base 132 and the Z-axis moving stage 131 to pass therethrough. The Y-axis auxiliary stage 144 may be spaced apart from the Z-axis base 132 and the Z-axis moving stage 131 along an inner perimeter of the rectangular hollow portion.

The inner flexures 145 are connected between the Y-axis auxiliary stage 144 and the Y-axis moving stage 141. An upper end of each inner flexure 145 is connected to the Y-axis auxiliary stage 144, and a lower end thereof is connected to the Y-axis moving stage 141. The inner flexures 145 may be disposed at left and right portions of the Y-axis moving stage 141.

Each inner flexure 145 may be formed in the shape of a rectangular plate having a thickness in the Y-axis direction smaller than a width in the X-axis direction, such that elastic deformation may be readily made by a force applied to the Y-axis moving stage 141 in the Y-axis direction.

The outer flexures 146 are connected between the Y-axis auxiliary stage 144 and the Y-axis fixed stages 142. An upper end of each outer flexure 146 is connected to the Y-axis auxiliary stage 144, and a lower end thereof is connected to the corresponding Y-axis fixed stage 142. The outer flexure 146 may have the same shape as the inner flexure 145. The outer flexures 146 may be disposed to respectively face the inner flexures 145 and to be parallel thereto.

The inner flexures 145 and the outer flexures 146 elastically deform to enable precise control of movement of the Y-axis moving stage 141 relative to the Y-axis fixed stage 142.

When a vertically upright flexure deforms into an S-shape, a phenomenon occurs in which the flexure becomes shortened in a longitudinal direction thereof, that is, along the Z-axis, which is referred to as a foreshortening effect. Since the Y-axis moving stage 141 is connected to the Y-axis fixed stage 142 via the inner flexures 145, the outer flexures 146, and the Y-axis auxiliary stage 144 to form a dual flexure stage, deformation of the inner flexures 145 and the outer flexures 146 is reduced by half, thereby compensating for the foreshortening effect.

The Y-axis actuator 147 moves the Y-axis moving stage 141 along the Y-axis. The Y-axis actuator 147 may be provided as a pair and disposed on left and right sides of the Y-axis moving stage 141. The Y-axis actuator 147 may be configured as a linear voice coil motor. A stator of the Y-axis actuator 147 may be fixed to the gantry vertical plate 143b, and a mover of the Y-axis actuator 147 may be fixed to the Y-axis moving stage 141.

Here, the Y-axis moving stage 141 may have mounting blocks that respectively extend upward from inner sides of left and right portions thereof. The mover of the Y-axis actuator 147 may be fixed to the mounting blocks of the Y-axis moving stage 141. The Y-axis actuator 147 may be controlled by the apparatus controller.

The load compensation mechanism 150 applies a force between the Z-axis base 132 and the gantry 143, based on the pressing force measured by the main load cell 120, to cancel a vertical reaction force acting on the pressing head 110. For example, the load compensation mechanism 150 may include load-compensation load cell 151 and the electromagnet actuator 152 for load compensation.

The load-compensation load cell 151 may be disposed on the same vertical axis as the main load cell 120 and may be mounted on the Z-axis base 132. The Z-axis base 132 may include a mounting piece that extends forward while being bent at 90 degrees from an upper end thereof. The load-compensation load cell 151 may be fixed to a lower surface of the mounting piece of the Z-axis base 132. A force measured by the load-compensation load cell 151 may be provided to the apparatus controller. The load-compensation load cell 151 may have various known configurations.

The electromagnet actuator 152 for load compensation may be mounted on a lower end of the load-compensation load cell 151. A center of action of the electromagnet actuator 152 for load compensation may be set to be located on the same vertical axis as a center of action of the vertical reaction force of pressing head 110.

The electromagnet actuator 152 for load compensation may be configured to generate a magnetic force by supplying current to a coil wound around an iron core. The electromagnet actuator 152 for load compensation may be controlled by the apparatus controller.

The electromagnet actuator 152 for load compensation may apply a vertical attractive magnetic force to the gantry 143 spaced downward therefrom. The electromagnet actuator 152 for load compensation may generate the attractive magnetic force such that the force measured by the load-compensation load cell 151 becomes equal to the pressing force measured by the main load cell 120.

An attractive force acting between the electromagnet actuator 152 for load compensation and the gantry 143 may be measured by the load-compensation load cell 151 and may be transmitted to the Z-axis base 132. When an attractive force equal to the pressing force measured by the main load cell 120 is transmitted to the Z-axis base 132, the vertical reaction force acting on the Z-axis base 132 may be canceled by the attractive force.

An example operation of the aforementioned precision press apparatus 100 will now be described.

After the pressing head 110 picks up an object, for example, a semiconductor chip, the pressing head 110 is lowered by the Z-axis driving mechanism 130 to press the semiconductor chip against a substrate. The pressing head 110 may apply a pressing force of several hundred newtons (N) to the semiconductor chip in a vertical direction. In this case, the main load cell 120 measures the pressing force applied by the pressing head 110 to the semiconductor chip.

When the pressing head 110 applies the pressing force to the semiconductor chip, a vertical reaction force corresponding to the pressing force acts on the pressing head 110 from the semiconductor chip. The vertical reaction force is transmitted to the Z-axis base 132. In this case, the electromagnet actuator 152 for load compensation of the load compensation mechanism 150 generates an attractive magnetic force such that the force measured by the load-compensation load cell 151 becomes equal to the pressing force measured by the main load cell 120. Then, the vertical reaction force acting on the Z-axis base 132 may be canceled by the attractive force by the electromagnet actuator 152 for load compensation.

Accordingly, the vertical reaction force acting on the pressing head 110 is transmitted along a path of the Z-axis base 132, the gantry 143, and the Y-axis fixed stage 142, as indicated by arrows in FIG. 5, and is thus not transmitted to the Y-axis moving stage 141 or to the inner flexures 145 and the outer flexures 146. As a result, the inner flexures 145 and the outer flexures 146 are prevented from being deformed into an undesired shape, and thus horizontal positioning accuracy of the pressing head 110 may not be degraded.

As described above, according to the precision press apparatus 100 of the present embodiment, horizontal positioning accuracy of the pressing head 110 can be ensured during the process of pressing an object with the pressing head 110. In addition, according to the precision press apparatus 100 of the present embodiment, a dual flexure stage can be applied to the Y-axis driving mechanism 140 even under operating conditions in which a pressing force of a substantial magnitude is applied to an object by the pressing head 110, thereby realizing horizontal positioning accuracy of the pressing head 110.

The present invention has been described with reference to one embodiment illustrated in the accompanying drawings; however, the embodiment is merely illustrative. Those of ordinary skill in the art will understand that various modifications and equivalent other embodiments may be made therefrom. Accordingly, the true scope of protection of the present invention should be defined only by the appended claims.

1. A precision press apparatus comprising:
a pressing head;
a main load cell mounted on an upper end of the pressing head and configured to measure a pressing force applied to an object by the pressing head;
a Z-axis driving mechanism including a Z-axis moving stage connected to an upper end of the main load cell and configured to move along a vertical Z-axis, a Z-axis base configured to movably support the Z-axis moving stage along the Z-axis, and a Z-axis actuator configured to move the Z-axis moving stage along the Z-axis;
a Y-axis driving mechanism including a Y-axis moving stage fixed to the Z-axis base and configured to move along a Y-axis on an XY horizontal plane, Y-axis fixed stages spaced outward from the Y-axis moving stage along the Y-axis, a gantry configured to connect the Y-axis fixed stages, a Y-axis auxiliary stage spaced upward from the Y-axis moving stage along the Z-axis, inner flexures connected between the Y-axis auxiliary stage and the Y-axis moving stage, outer flexures connected between the Y-axis auxiliary stage and the Y-axis fixed stages, and a Y-axis actuator configured to move the Y-axis moving stage along the Y-axis; and
a load compensation mechanism configured to apply a force between the Z-axis base and the gantry, based on the pressing force measured by the main load cell, to cancel a vertical reaction force acting on the pressing head.

2. The precision press apparatus of claim 1,
wherein the gantry is made of a magnetic material, and
the load compensation mechanism comprises:
a load-compensation load cell arranged on a same vertical axis as the main load cell and mounted to the Z-axis base; and
an electromagnet actuator for load compensation mounted on a lower end of the load-compensation load cell and configured to apply a vertical attractive magnetic force to the gantry spaced downward therefrom and to generate the attractive magnetic force such that a force measured by the load-compensation load cell becomes equal to the pressing force measured by the main load cell.

3. The precision press apparatus of claim 2,
wherein the gantry comprises:
a gantry horizontal plate disposed downward from the electromagnet actuator for load compensation by a set gap; and
gantry vertical plates connected between the gantry horizontal plate and the Y-axis fixed stages.
